(19) United States
(12) Patent Application Publication
(10) Pub. No.: US 2014/0169400 A1
(43) Pub. Date: Jun. 19, 2014

(54) SYSTEM AND METHOD OF APPROXIMATING CALORIC ENERGY INTAKE AND/OR MACRONUTRIENT COMPOSITION

(71) Applicant: Access Business Group International LLC, Ada, MI (US)

(72) Inventors: David W. Baarman, Fennville, MI (US); Matthew K. Runyon, East Grand Rapids, MI (US); Cody D. Dean, Grand Rapids, MI (US); Neil W. Kuyvenhoven, Ada, MI (US)

(73) Assignee: Access Business Group International LLC, Ada, MI (US)

(21) Appl. No.: 14/085,861

(22) Filed: Nov. 21, 2013

Related U.S. Application Data
(60) Provisional application No. 61/739,271, filed on Dec. 19, 2012.

(51) Int. Cl. G01N 25/00

(52) U.S. Cl. CPC G01N 25/00
USPC 374/45

(57) ABSTRACT

Systems and methods for approximating caloric energy intake and/or macronutrient composition using thermogenesis. The system may include one or more sensors for tracking body temperature over a period of time, and may include a processor configured to determine caloric energy intake and/or macronutrient composition based on body temperature. The system may be configured to normalize body temperature readings to compensate for factors other than thermogenesis that might affect core body temperature. The system may include one or more sensors for measuring normalization factors, and a processor for normalizing raw body temperature readings based on the measured normalized factors. The method may include the steps of: (a) collecting body temperature data, (b) normalizing the raw body temperature data and (c) determining caloric energy intake and/or macronutrient composition from the normalized data. The system may be configured to account for user calibration data when characterizing macronutrient composition.

### BACKGROUND OF THE INVENTION

The present invention relates to automated systems and methods for monitoring user activities relating to health and well-being, and more specifically to systems and methods for approximating caloric energy intake and/or macronutrient composition.

There is a growing interest in developing automated systems capable of promoting health and well-being. For example, there are multiple mobile devices on the market focused on weight management, such as FitBit™ and BodyMedia™. These devices track daily caloric energy expenditure (EE) using 3-axis accelerometers and daily energy intake using PC and/or phone-based food logs. These food logs require the user to manually enter everything they eat and this information is converted to caloric energy intake (EI). These conventional systems may suffer from a variety of disadvantages. For example, it can be time consuming for a user to manually enter food consumption information into the system. It may also be challenging for a typical user to identify food type, serving size and other types of information that might be useful in characterizing consumed food. Even when food type, serving size and other similar types of information are available, it can be difficult for a user to obtain nutritional information for consumed food. Further, a user will often consume food in a location remote from the computer used to track food consumption. Accordingly, the user may be required to remember or take the time to write-down the information for later entry into the computer. As a result of these and other shortcomings, conventional systems are inconvenient to use and prone to significant error.

### SUMMARY OF THE INVENTION

The present invention provides a system and method for approximating caloric energy intake and/or macronutrient composition using thermogenesis. In one embodiment, the system includes one or more sensors for tracking body temperature over a period of time to determine caloric energy intake and macronutrient composition of consumed food. In one embodiment, the system includes one or more temperature sensors located in positions that provide temperature data representation of core body temperature. For example, a sensor or network of sensors may be disposed on the user's body at one or more locations that permit a sufficiently accurate measurement of core body temperature.

In one embodiment, the sensor or sensors may be located in a device worn by the user, such as a wristband, anklet, ear piece or other similar device. In another embodiment, the sensor or sensors may be one or more epidermal skin sensors that can be applied directly to the user's skin. Epidermal skin sensors may be applied in essentially any location that provides accurate measurements. For example, epidermal skin sensors may be applied to the chest or in the armpit region of a user. In still other embodiments, a network of temperature sensors may include one or more sensors located in a device worn by the user and one or more epidermal skin sensors applied to the user's skin. If desired, a removable temperature sensor may be temporarily placed in contact with the skin when it is desirable to take temperature measurements. For example, a removable temperature sensor may be used to temporarily take the temperature of a user's forehead or scalp. As another example, a removable ear piece may be periodically place in an ear to collect temperature data. The ear piece need not be removable and may have the ability to pass sound using essentially the same circuitry as a hearing aid.

In one embodiment, the system is configured to develop a temperature profile for a meal from readings taken over a period time associated with that meal. For example, the temperature profile may start at the beginning of the meal and extend for a fixed period of time, such as six hours. The period of time need not, however, be fixed. For example, it may begin at the start of a meal and stop when the thermic effect of food has sufficiently fallen off. As another example, the period of time may stop if another meal is eaten before the time has expired. With this embodiment, the system may include an input device that allows the user to indicate the start of a meal. For example, the system may include a button, switch or other user input to flag the start of a meal. One alternative is to provide a device with integrated accelerometers or other motion sensors that allow the user to signal the start of a meal by making a specific gesture with the device. In one embodiment, the system is configured to determine caloric energy intake and/or macronutrient composition from the temperature profile based on the Thermogenic Maximum (TGM), Time to Thermogenic Maximum (TTM) and Total Thermogenic Response (TTR) of the temperature profile.

In one embodiment, the system may be configured to normalize body temperature readings to compensate for factors other than thermogenesis that might affect core body temperature. The number and types of normalization factors may vary from application to application. However, in one embodiment, the system may include one or more additional sensors that monitor physical activity levels of the user, ambient temperature, UV exposure and/or time of day. Other normalization factors may include factors such as menstrual cycle, wind speed and humidity level. The system may include a processor capable of normalizing body temperature readings based on the readings from the sensors for the normalization factors. In one embodiment, biometric and physiological data about the user, such as age, height, weight, gender, race and level of fitness, may be taken into consideration during normalization of the raw body temperature readings.

In one embodiment, the system includes a processor capable of processing raw temperature data, as well as other data (e.g. normalization data), to provide caloric energy intake and/or macronutrient composition. The processing capability may be integrated into a device that carries one or more sensors. That device may obtain all of the necessary temperature data from an on-board sensor (or sensors) or it may obtain at least some of the temperature data from remote sensors or remote devices that incorporate sensors. When obtaining temperature data remotely, the data may be communicated using conventional wireless communications protocols, such as Bluetooth, WiFi or NFC. The data may, however, be communicated in other ways, for example, using a corded connection or using communications techniques that are integrated into a wireless power supply, such as backscatter modulation. As an alternative to incorporating the processing capability into a device that carries one or more sensors, the processing capability may be integrated into a separate device. For example, the system may include a central device that is capable of receiving and processing temperature data and other relevant data (e.g. normalization data) from a network of remote sensors.

In one embodiment, the system includes a processor capable of generating a temperature profile and using the temperature profile to predict the macronutrient composition of consumed food. The system may include data storage for storing user calibration data useful in characterizing macronutrient composition based on temperature profile. The calibration data may be an algorithm (or collection of algorithms) or it may be a table or other form of data collection that allows information collected from normalization sensors to be converted into an adjustment for the raw temperature readings. In one embodiment, the user calibration data will represent the results of calibration tests conducted on the user. In other embodiments, the user calibration data may represent the results of calibration tests conducted on a test group. In some embodiments, the user calibration data may represent the combined results of calibration tests conducted on the user and a test group. The calibration data may include temperature collected in connection with the consumption of one or more meals of known macronutrient composition.

In one aspect, the present invention provides a method for determining caloric energy intake including the steps of: (a) collecting data representing a user's body temperature over a period of time, (b) normalizing the raw body temperature data and (c) determining caloric energy intake as a function of the normalized body temperature data. The method may include the steps of tracking and quantifying changes in an individual's body temperature throughout a day (specifically after a meal) and normalizing and correcting the raw temperature data by combining sensors that monitor activity levels, ambient temperature, UV exposure, and time of day. The present invention may employ methods and equations that allow temperature profiles after meal consumption to predict the macronutrient composition of a meal.

In one embodiment, the step of determining caloric energy intake may include the steps of developing equations calibrated for the user. The calibrated equations may be developed by having the user consume a plurality of meals of known macronutrient composition, developing a body temperature profiles representing the TEF for each of the consumed meals and calibrating the caloric energy intake equations as a function of the TGM, TTM and TTR of the temperature profiles. In one embodiment, each of the plurality of meals is provided with different percentages of the different macronutrients.

The present invention provides simple and effective systems and methods for approximating caloric energy intake and/or macronutrient composition. The systems and methods are based on thermogenesis and therefore can be implemented using relatively inexpensive and non-invasive temperature sensors. The present invention provides systems and methods that overcome the shortcomings of conventional systems that require manual entry of information relating to caloric energy intake. The systems and methods may incorporate normalization of the raw body temperature readings to improve the accuracy of the caloric energy intake and/or macronutrient composition approximations. The systems and methods may be capable of normalizing for essentially any environmental factors that might impact body temperature readings. The systems and methods are capable of implementing one or more normalization factors to improve the accuracy of the approximations, as desired. The systems and methods may be capable of calibrating for user-specific variations, such as metabolic function, age, height, weight, gender, race and level of fitness, to improve the accuracy of the caloric energy intake and/or macronutrient composition approximations. The systems and methods allow implementation of the normalization and calibration capabilities at different levels based on various factors, such as system cost, desired accuracy and user convenience.

These and other features of the invention will be more fully understood and appreciated by reference to the description of the embodiments and the drawings.

### BRIEF DESCRIPTION OF THE DRAWINGS

FIG. 1 is a schematic representation of a system for approximating caloric energy intake and/or macronutrient composition in accordance with an embodiment of the present invention.

FIG. 2A is a graph showing intake calories against thermic effect of food.

FIG. 2B is a three-dimensional graph showing intake calories and the thermic effect of food over time.

FIG. 3 shows two graphs that reflect correlation between indirect calorimetry and whole body temperature.

FIG. 4 is a representation of an epidermal skin sensor and a shirt configured to provide multi-point body temperature measurements.

FIG. 5A shows a graph and equations that can be used in one embodiment to convert changes in body temperature into Thermogenic Maximum (TGM), Time to Thermogenic Maximum (TTM), and Total Thermogenic Response (TTR).

FIG. 5B shows a graph and equations that can be used in one embodiment to convert changes in body temperature into Thermogenic Maximum (TGM) for protein.

FIG. 6 shows equations that can be used in one embodiment to determine the coefficients used in the TGM equation shown in FIG. 5A.

FIG. 7 shows equations that can be used in one embodiment to determine the coefficients used in the TTM equation shown in FIG. 5A.

FIG. 8 shows equations that can be used in one embodiment to determine the coefficients used in the TTR equation shown in FIG. 5A.

FIG. 9 is a schematic representation of an alternative system having a personal device and a remote temperature sensor.

FIG. 10 is a graph showing changes in body temperature of a female over the menstrual cycle.

FIG. 11 is a graph showing changes in body temperature in response to physical activity.

FIG. 12 is a schematic representation of an alternative system having a remote sensor, a personal device and a cell phone.

FIG. 13 is a graph showing TGM for individual macronutrients.

FIG. 14 is a graph showing changes in body temperature for different physical activity levels.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DESCRIPTION OF CURRENT EMBODIMENTS

### A. Overview

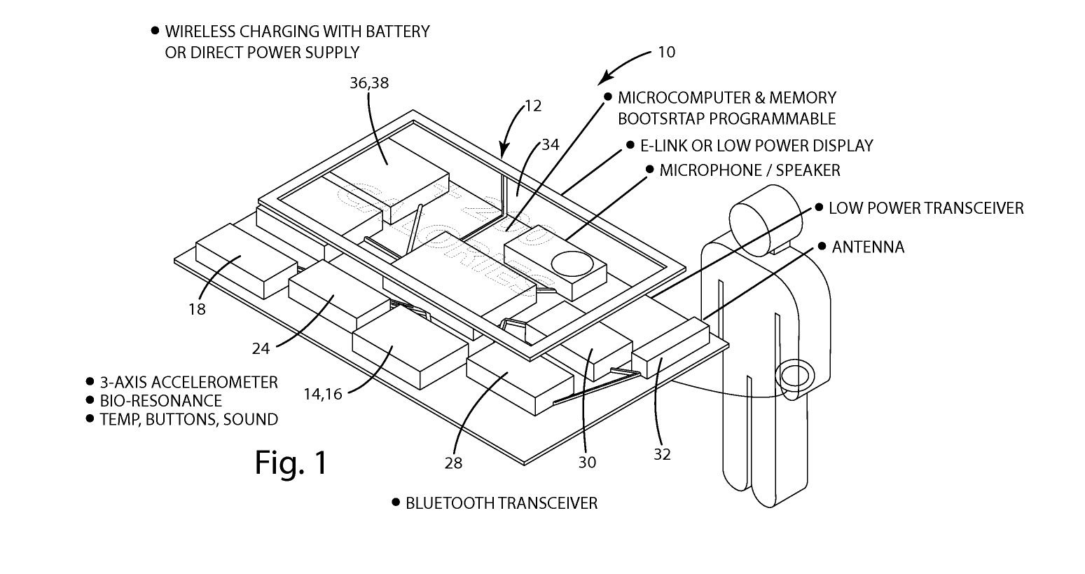

A system 10 for approximating caloric energy intake and/or macronutrient composition of consumed food is shown in FIG. 1. In this embodiment, the system is implemented in a device 12 that may be worn by a user. The device 12 of FIG. 1 is configured to tracks caloric intake of a user by measuring and normalizing body temperature throughout a day and, in this embodiment, specifically before and after a meal. The device 12 of FIG. 1 includes an ambient temperature sensor 14, body temperature sensor 16 and motion sensor 18. Each one of these sensors may be a single sensor or a plurality of sensors. For example, body temperature may be tracked using readings collected from a plurality of different temperature sensors 16 located at different locations on the body. As another example, the motion sensor 18 may include different types of motion sensors, such as a three-axis accelerometer, a pedometer, a gyroscope and a magnetometer. The device 10 may include additional sensors that may be used to further improve the accuracy of the system. Examples of additional sensors that could be included in the system include a galvanic skin sensor and a UV dosimeter. In use, the device 12 collects body temperature readings using the temperate sensors 16; collects data relevant to normalization factors that might affect the raw temperature readings, such as physical activity using motion sensor 18; normalizes the raw temperature readings; and computes an approximation of caloric energy intake and/or macronutrient composition of consumed food.

Although the embodiment of FIG. 1 is an implementation of the present invention contained in a single device, the present invention may be implemented in a wide variety of alternative devices or networks of devices (or other components). For example, the present invention may be implemented in a plurality of discrete components that are networked or otherwise capable of operating cooperatively to carry out the present invention. As discussed in more detail below, the present invention may, for example, be implemented in a network of components including a central processing device and a plurality of separate sensors that provide data to the device. The present invention may, if desired, be incorporated into larger automated systems, such as automated systems that relate to health and well-being, such as behavior modification systems. For example, the present invention may be incorporated into a behavior modification system in accordance with the teachings of U.S. Provisional Application No. 61/567,962, entitled “Behavior Tracking and Modification System” and filed on Dec. 7, 2011, and/or PCT Application No. PCT/US12/68503, entitled “Behavior Tracking and Modification System” and filed on Dec. 7, 2012, both of which are incorporated herein by reference in their entirety.

### B. Thermogenesis

Thermogenesis is the process of heat production in animals. In warm blooded animals heat is generated by three main thermogenic processes: i) exercised induced, ii) non-exercised induced, and iii) diet induced. The later form of thermogenesis is often referred to as the thermic effect of food (TEF). Thermic effect of food is the increase in thermogenesis after the consumption of macronutrients. This meal-induced thermogenesis can last for about 6 hours after the consumption of food.

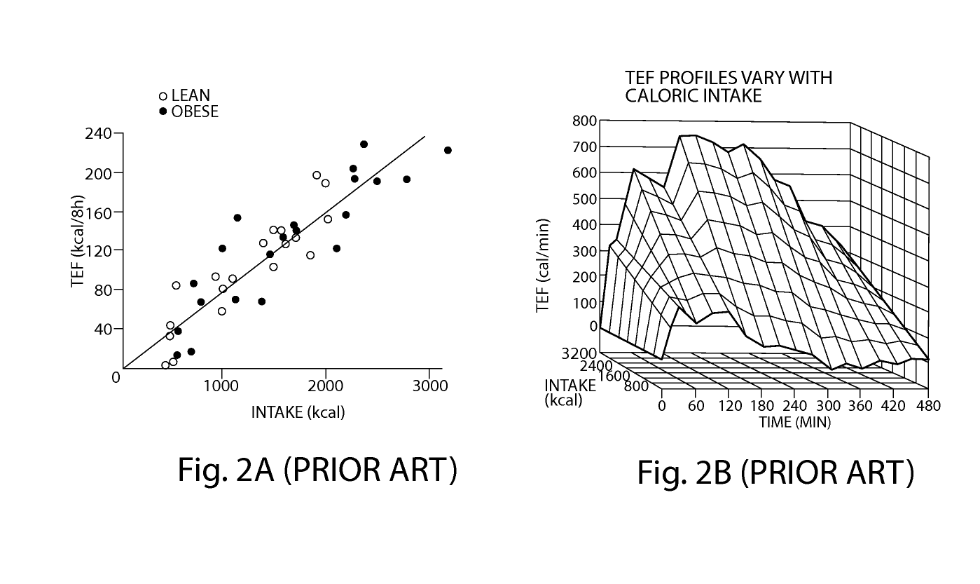

The thermic effect of food can be measured using both direct and indirect calorimetry. Direct calorimetry measures the increase in whole body temperature that occurs after consumption of a meal. Whole body temperature changes can be measured by placing and individual into a metabolic chamber. Indirect calorimetry measures the amount of oxygen consumed and the amount carbon dioxide exhaled by an individual. This measurement technique results in an indirect measure of heat generated. This measurement is typically accomplished using a VO2/CO2 metabolic chart. FIGS. 2A and 2B are graphs from a third party study that demonstrate the correlation between the thermic effect of food and indirect calorimetry and whole body temperature.

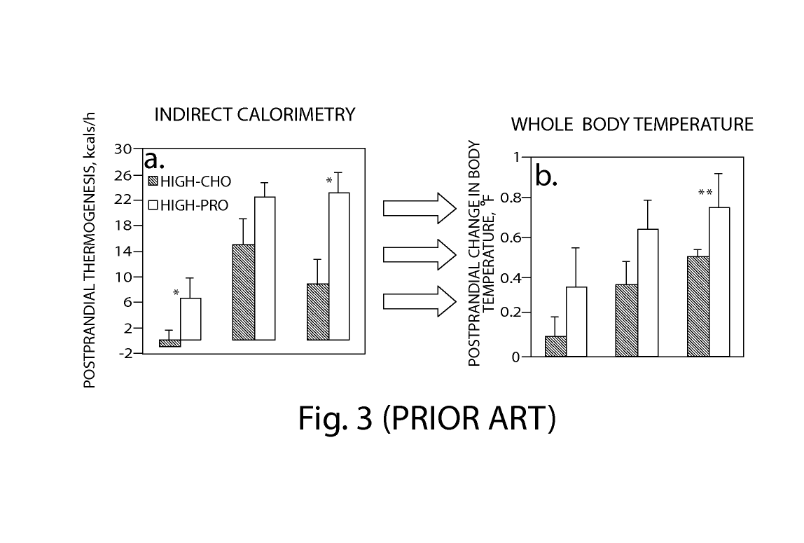

Generally speaking, the increase in magnitude of thermogenesis in response to a meal is dependent on both the number of calories consumed and the macronutrient composition of the meal. The three macronutrients that can be present in food are proteins, fats, and carbohydrates. Protein has the highest thermogenic effect, followed by carbohydrates, and then fats. For example, FIGS. 3A and 3B are graphs from a third party study that show the correlation between the thermic effect of food and body temperature and macronutrient composition.

### C. Personal Device

As noted above, the present invention may be implemented in a wide variety of devices or network of devices/components. In the embodiment of FIG. 1, the present invention is implemented into a personal device 12 that can be worn by a user and is configured to track caloric intake and/or macronutrient composition by measuring and normalizing body temperature throughout a day and specifically before and after a meal. In this embodiment, the device 12 may generally include an ambient temperature sensor 14, a body temperature sensor 16 and a motion sensor 18. The device 12 may include additional sensors that might assist in approximating caloric energy intake and/or macronutrient composition. For example, additional sensors may be provided to collect data relevant to factors that might assist in normalizing body temperature data. If desired, the device 12 may include a galvanic skin sensor (not shown) capable of measuring sweat, which may be useful in normalizing body temperature data to compensate for physical activity and/or user hydration. The device 12 may also include a UV dosimeter (not shown) capable of measuring UV exposure, which may be useful in normalizing body temperature date to compensate for sun exposure. The sensors used to collect data relevant to approximation of caloric energy intake and macronutrient composition may be incorporated into the device 12 or may be remote sensors that are incorporated into other devices or other system components. Remote sensors may include communications circuitry that allow them to communication measured data to the device 12 or another central device using wired or wireless communications systems. Remote sensors may be capable of storing measurement that can be communicated to the device 12 and/or they may be capable of providing real-time measurements when polled by the device 12.

The device 12 may also include a variety of additional components intended to provide additional capabilities, including, for example, circuitry configured to receive and transmit data and information with other system components, such as other devices and/or remote sensors. The device 12 of FIG. 1 is capable of being worn or carried by a user, and may be in the form of a bracelet, wristband, anklet, earpiece or other wearable item, or it may be in another convenient form, such as a clip-on device or a device capable of being placed within a pocket. The device 12 may be provided with an input device to permit the user to enter data into the device. The input device (not shown) may be essentially any type of human input device, such as a touch screen, buttons, switches, keyboard or other human interface devices. If desired, the device 12 may receive user input via a separate system component. For example, the device 12 may be capable of communicating with a personal computer, tablet computer or cell phone, and the user may input any desired information into the separate system component and that component may transfer the input to the device 12. The device 12 is described with a variety of features and functions. Unless otherwise expressly noted, those features, functions, or combinations thereof may be incorporated into other devices, sensors or other system components.

Referring again to FIG. 1, the device 12 of the illustrated embodiment may include temperature sensors (ambient temperature sensor(s) 14 and body temperature sensor(s) 16), a 3-axis accelerometer 18, bio-impedance and bio-resonance measurement circuitry 24, microphone and speakers 26, a Bluetooth Low Energy (BTLE) transceiver 28, a 916.5 MHz low power transceiver 30, an antenna 32 or set of antennas, a display 34, a battery 36, and a wireless power transceiver 38. The device 12 is described in connection with all of these components, but in alternative embodiments, the device 12 may include some components but not others. For example, in one embodiment, the device 12 may not include the bio-impedance and bio-resonance measurement circuitry 24 or may not include the low power transceiver 30.

Body temperature sensor(s) 16 and ambient temperature sensor(s) 14 may be incorporated into the device 12 and/or may be separate remote temperature sensors that are capable of providing temperature data to the device 12, for example, using wired or wireless communications, such as Bluetooth, WiFi, NFC or RF communications. When body temperature sensors are incorporated into the device 12, a temperature sensor may be positioned on an interior surface that generally remains in contact with the user's skin to periodically collect body temperature readings. The device 12 may alternatively include a temperature sensor that is on an external surface and is placed in contact with the body each time a temperature reading is desired. When remote body temperature sensors are included, they may be placed where they will provide measurements that are most similar to core body temperature. For example, remote temperature sensors 16 may be located on the chest or forehead, or in the arm pit. Remote temperature sensors 16 may additionally or alternatively be placed over body organs, such as the kidneys, stomach or liver.

Similarly, the ambient temperature sensor(s) 14 may be positioned where it will provide temperate readings that most accurately represent ambient temperature. For example, an ambient temperature sensor may be located on the exterior of the device 12 where it is exposed to ambient air and isolated from body temperature as much as possible. As another example, the ambient temperature sensor may be a remote sensor (e.g. separate from the device 12) that is located away from the user where it may provide a more accurate measure of ambient temperature. When the ambient temperature sensor is a remote sensor, it may be capable of communicating its readings to the device 12 or to a central device.

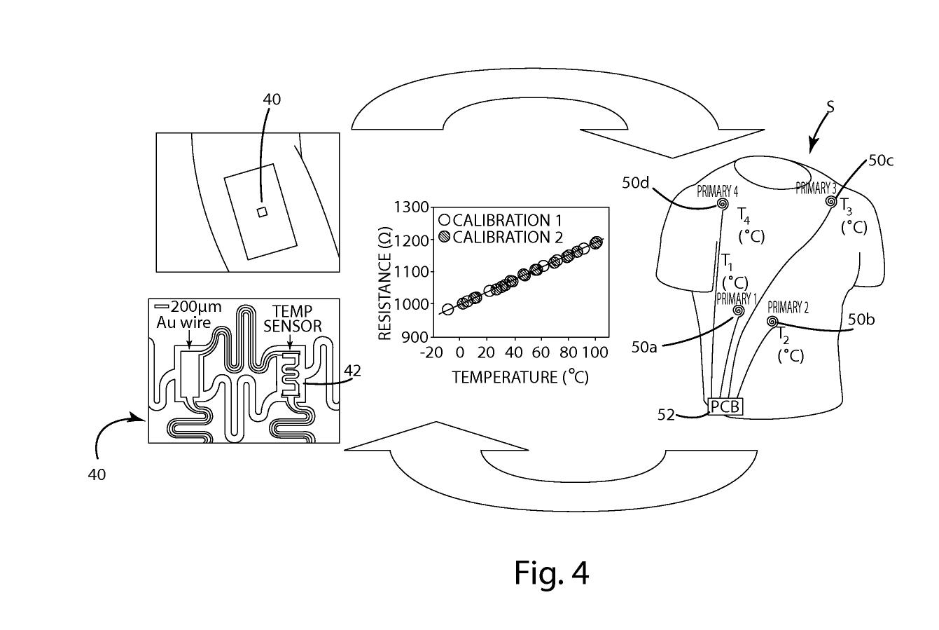

Examples of the temperature sensors include thermocouples, thermistors and resistance temperature detectors. Another example of a temperature sensor is an epidermal skin sensor. Epidermal skin sensors have been demonstrated and are now available commercially, for example, from mc10 Incorporated of Cambridge, Mass. Epidermal skin sensors are typically thin (˜25-75 μm), stretchable, and can be in conformal contact with human skin. FIG. 4 illustrates several remote temperature sensors, including an epidermal skin sensor 40 and a shirt S with an array of body temperature sensors 40. The epidermal skin sensor 40 may communicate temperature data to the device 12 using any form of wired or wireless communication. In one embodiment, the epidermal skin sensor 40 may be configured to be energized by an external RF signal. For example, the epidermal skin sensor 40 may have an inductor (not shown) that is capable of generating electrical energy when subjected to an appropriate RF field. The temperature sensor 42 within the epidermal skin sensor 40 may be configured so that variations in temperature cause variations in the reflected impedance of the epidermal skin sensor 40. For example, the temperature sensor 40 may be a variable impedance element in which the impedance varies as a function of temperature. The variable impedance element may be operatively coupled to the inductor (not shown) so that the impedance of the variable impedance element has an impact on the reflected impedance of the epidermal skin sensor 40. In use, the epidermal skin sensor 40 may be energized by an RF signal provided by the device 12, and the reflected impedance of the epidermal skin sensor 40 may be measured within the device 12 to determine the real-time value of the temperature sensor within the epidermal skin sensor 40. In an alternative embodiment (not shown), the epidermal skin sensor 40 may be provided with a controller, a wireless communications circuit and an electrical energy storage device, such as a super capacitor or a battery. In this embodiment, the epidermal skin sensor 40 can run on its own power and obtain temperature readings over time. The temperature readings may be wirelessly communicated to the device 12 or other system component in real-time. If desired, the epidermal skin sensor 40 could include data storage, and could collect temperature readings over a period of time and periodically communicate temperature readings to the device 12 or other system component. In this embodiment, the shirt S may include a central processor 52 that collects data from the sensors 50a-d. The central processor 52 may be capable of communicating the data to the device 12 using essentially any form of wired or wireless communication. Although the shirt S is shown with four temperature sensors 50a-d, the number and location of temperature sensors may vary from application to application as desired.

As noted above, the device 12 of FIG. 1 includes physical activity sensors 18. Examples of the activity sensor include 3-axis accelerometers, pedometers and gyroscopes, but may include other types of activity, motion, position or orientation sensors. The data collected by these sensors 18 may be used to normalize raw body temperature data to compensate for changes to core body temperature caused by physical activities, such as exercise (as described in more detail below).

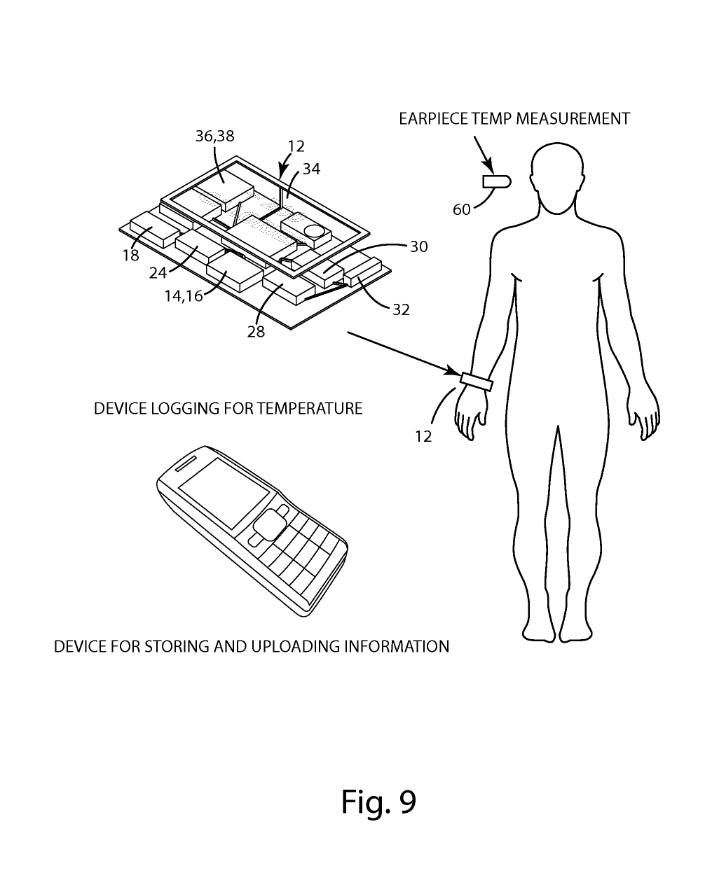

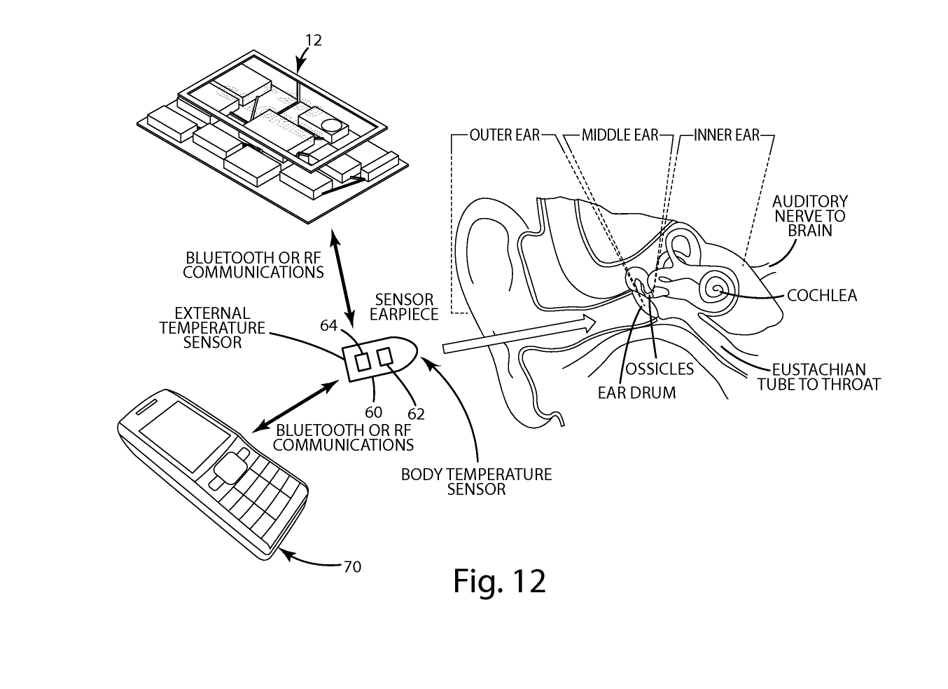

Another example of a remote sensor 60 is shown in FIGS. 9 and 12. FIGS. 9 and 12 show an earpiece that could be worn by a user to collect body temperature. In this embodiment, the remote sensor 60 is configured to communicate the body temperature measurements to the remote device 12, for example, using wireless communications. The remote sensor of FIGS. 9 and 12 generally includes temperature sensing circuitry 62 for taking body temperature measurements, data storage for collecting the body temperature measurements and communications circuitry 64 for communicating the measurements to the device 12. Although the body temperature measurements are communicated to the device 12 in this embodiment, they may be communicated to other devices in the system 10, if desired. For example, in some embodiments, the processing may take place in a processor separate from the device 12, for example, in a central network component that is capable of receiving data from the from the device 12 and the remote sensor 60. As another example, the remote sensor 60 may be capable of communicating its stored data to a cell phone 70 or other intermediate device that could relay the information to device 12 or a central processor (not shown) for processing. The earpiece could be similar to a hearing aid so that the person did not have to take it out and it wouldn't affect their hearing. By leaving it in for long periods, the remote sensor 60 may provide better temperature measurements. If desired, a 3-axis accelerometer or other motion sensor may be incorporated into the remote sensor 60. By collecting more activity data from multiple spots, the remote sensor 60 in the ear and the device 12 on the wrist, for example, the system 10 may be able to make activity calculations more accurately.

### D. Methods

The present invention also provides method for approximating caloric energy intake and/or macronutrient composition of consumed food. In one embodiment, the method approximates caloric energy intake including the steps of: (a) collecting data representing a user's body temperature over a period of time, (b) normalizing the raw body temperature data and (c) determining caloric energy intake as a function of the normalized body temperature data. The method may include the steps of collecting core body temperature data during a period of time, for example, during a period of time beginning at the start of a meal. The method may include the step of generating temperature profiles after meal consumption to predict the macronutrient composition of a meal. The method may include the steps of normalizing and correcting the raw temperature data using data from sensors that monitor one or more of activity levels, ambient temperature, UV exposure, menstrual cycle and time of day.

As noted above, body temperature readings may be collected using one or more temperature sensors 16. The body temperate readings may be taken periodically over a period of time and may be used to develop a temperature profile. Alternatively, temperature readings may be taken periodically on a continuous-basis, rather than over a period of time. In one embodiment, the body temperature readings begin at the start of a meal and are taken periodically for a fixed period of time. In one embodiment, readings are taken for a period of six hours from the start of a meal. If a fixed-length period is used, the length of the period may vary from application to application. For example, the typical length of TEF for a given user may be determined through testing and that typical length may be used as the fixed-length for that user. Temperature readings need not be taken over a fixed period of time. For example, temperature readings may begin at the start of a meal and stop when the thermic effect of food has sufficiently fallen off. As another example, the period of time may stop if another meal is eaten before the time for the preceding meal has expired.

With this embodiment, the system may include an input device that allows the user to indicate the start of a meal. For example, the system may include a button, switch or other user input to flag the start of a meal. One alternative is to provide a device with integrated accelerometers or other motion sensors that allow the user to signal the start of a meal by making a specific gesture with the device. For example, a user may shake the device in a predetermined way to signal the start of a meal.

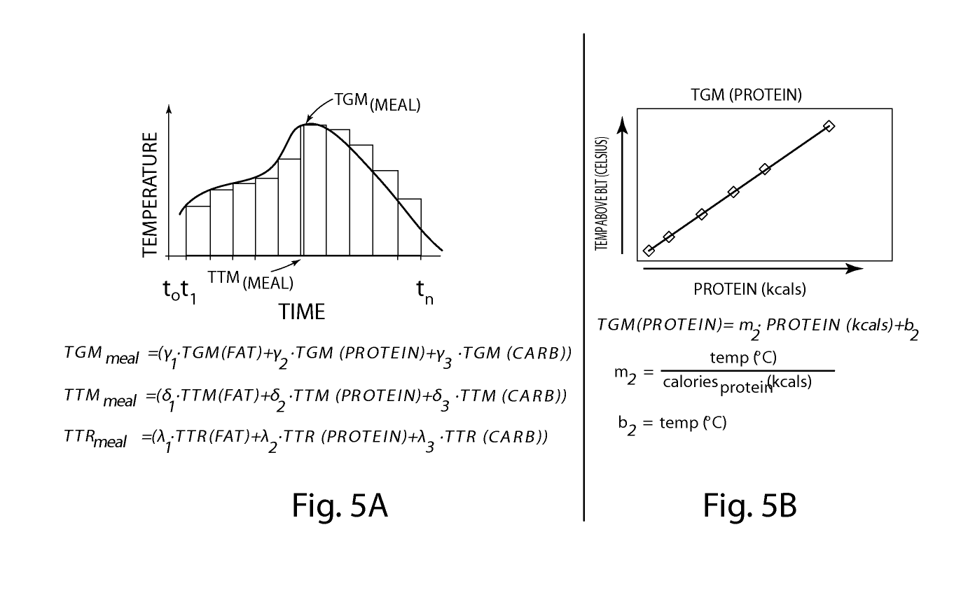

As discussed in more detail below, body temperature readings will be converted into energy intake using the equations described in FIGS. 5-8. The expected increase in body temperature due to TEF is between 0.1° C. and 5.0° C. depending on the caloric amount and the macronutrient ration in the meal. Because of these small increases in body temperature after meal consumption, this embodiment of the method includes the step of normalizing the body temperature readings based on multiple factors. Examples of factors that may have an impact on an individual's body temperature include: i) physical activity, ii) environmental (or ambient) temperature, iii) exposure to sunlight, iv) time of day, v) menstrual cycle and vi) illness. The method may be configured to adjust for other factors that are found to impact body temperature.

In this embodiment, the method includes the step of normalizing raw core body temperature readings for factors other than TEF that could impact those readings using additional device-based and networked sensors. For example, time of day will be accounted for with an internal clock; body temperature increases associated with activity could be normalized based on the reading of the activity sensor; body temperature changes associated with environmental temperature could be normalized using the ambient temperature sensor; and skin temperature increase due to exposure to sun could be normalized using a UV dosimeter.

Time of day may affect internal body temperature. For example, the body temperature of an individual may increase and decrease over the day. To accommodate for these variations, it may be desirable to adjust raw body temperature readings based on the time of day. In one embodiment, normalization for time of day may be achieved by adjusting the raw temperature readings based on a time-of-day temperature profile. The time-of-day profile may be developed by monitoring variations in the user's own internal body temperature over time under controlled conditions. These variations may be analyzed to develop an algorithm for converting time of day into an adjustment for the raw body temperature data. The algorithm may be mathematical formula that converts time of day into a number that can be added or subtracted from the raw body temperature. Alternatively, the algorithm may be a table or other arrangement of data that can be used to convert time of day into a number that can be used to normalize raw body temperature. As an alternative to running controlled tests with the user of the system, the time-of-day profile may be developed by monitoring time-of-day variations in the internal body temperature of a test group under controlled conditions. Again, the variations may be analyzed to develop an algorithm (e.g. formula or table) for converting time of day into an adjustment for the raw body temperature data. It should be noted that variations may differ in different groups of people. For example, age, gender, race, height, weight and level of fitness may have a material impact of the variations that occur over the time of day. Accordingly, different algorithms may be developed for different groups of people.

Physical activity may also affect internal body temperature. Heavy physical activity can significantly increase internal body temperature. Normalization for physical activity may be achieved by adjusting the raw temperature readings based on an activity temperature profile. The activity temperature profile may be developed by monitoring variations in the user's own internal body temperature during various levels of physical activity, as discussed above in connection with time-of-day normalization. Alternatively, the activity temperature profile may be developed by monitoring variations in the internal body temperature of a test group during various levels of physical activity under controlled conditions, as discussed above in connection with time-of-day normalization.

Body temperature will also vary with the temperature of the environment (e.g. ambient temperature). For example, a user's core body temperature will typically increase when the temperature of the environment increases. Similarly, a user's core body temperature may decrease in a colder environment. Normalization for ambient temperature may be achieved by adjusting the raw temperature readings based on an ambient temperature profile. The ambient temperature profile may be developed by monitoring variations in the user's own internal body temperature when subjected to different ambient temperatures, as discussed above in connection with time-of-day normalization. Alternatively, the ambient temperature profile may be developed by monitoring variations in the internal body temperature of a test group when subjected to different environmental temperatures under controlled conditions, as discussed above in connection with time-of-day normalization.

Exposure to the sun can also have a material impact on raw temperature readings. For example, increased exposure to the sun can materially increase skin temperature, which can affect the readings of temperature sensors that measure skin temperature. UV exposure can also increase core body temperature. As a result, it may be desirable to normalize raw temperature readings to compensate for UV exposure. Normalization for UV exposure may be achieved by adjusting the raw temperature readings based on a UV temperature profile. The UV temperature profile may be developed by monitoring variations in the user's own internal body temperature when subjected to different levels of UV exposure, as discussed above in connection with time-of-day normalization. Alternatively, the UV temperature profile may be developed by monitoring variations in the internal body temperature of a test group when subjected to different levels of UV exposure under controlled conditions, as discussed above in connection with time-of-day normalization.

The steps associated with normalization for physical activity will now be described in more detail. Looking at FIG. 11, it can be seen that when a person is active the person's body temperature is higher. With relationships like this, it may be possible to perform some initial testing to develop an algorithm that determines a person's change in body temperature based on activity level and physical characteristics. For example, the method may rely on a small pilot study varying age, sex, weight, height and other potentially relevant factors along with activity and measure the body temperature. The results of this study may be used to generate equations specific to different groupings of people. This data would be similar to the example in FIG. 14. For the example in FIG. 14, the method may include having a person with specific characteristics run at different speeds and measuring that person's body temperature. Doing this for many individuals will allow the development of specific algorithms predicting temperature with activity for groups of people. In use, a user of the system 10 could then enter their characteristics into the device (age, height, weight, sex, etc). Based on the testing noted above, the appropriate algorithm could be used based on which group the user falls in, and then as the activity sensor measured that person's activity, an accurate prediction of temperature could be calculated using the algorithm. This (and other normalization factors) would then be subtracted off the measured temperature during thermogenesis so that the raw temperature readings only reflect heating from thermogenic effects and not activity (or other normalization factors).

Body temperature changes associated with environmental temperature could be normalized using the ambient temperature sensor. Finally, skin temperature increase due to exposure to sun could be normalized using a UV dosimeter. In this embodiment, both of these examples may be calibrated the same way where UV dose would be correlated to body temperature and a function would be developed so that whatever reading the UV dosimeter reported, could be converted to an adjustment for the raw body temperature readings.

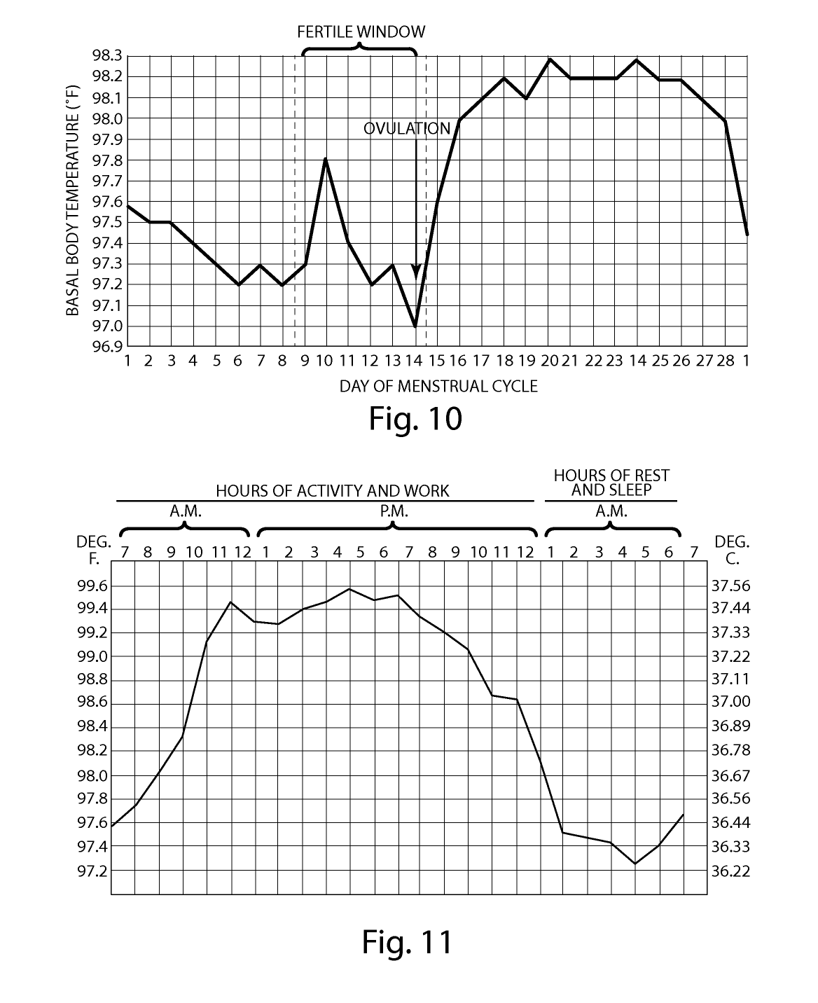

Another method to normalize for different variables affecting body temperature is to create a temperature profile over time. In one embodiment, this may involve device 12 measuring body temperature many times in a day during predetermined times where it is known that activity and food is not affecting the measurement. The values can then be averaged and plotted over a certain time period. This plot would represent a temperature profile and it could be used to understand internal temperature shifts not based on activity or food. A woman's menstrual cycle is one example of this. Research has shown that body temperature changes over a woman's menstrual cycle, which can be seen in FIG. 10. In this embodiment, testing is performed to determine if temperature shifts correlated between women over their cycle. If this proves to be true, a method similar to the one described above can be used to normalize for menstrual cycle variations. For example, the woman may enter her typical starting and ending date of her cycle and the internal clock in the device would be used in combination with the data contained in the graph of FIG. 10 (or an equation developed from a best fit curve) to know how much to shift the temperature based on the day within the menstrual cycle. If correlations between women are not present, an averaging method may be used. By laying the temperature profile over a timeline, the system may account for shifts in the body temperature not due to activity or food. The temperature profile could look like the graph of FIG. 10, and the longer a person wore a device, the more accurate the profile could become.

Experience has revealed that TEF may vary from individual to individual. For example, factors such as metabolism rate may cause variations in the changes to core body temperature experienced as the result of food consumption. These variations may be specific to individual macronutrients. For example, different individuals may obtain different thermic effects from fats, proteins and/or carbohydrates. Other examples of factors that may be relevant to caloric energy intake and/or macronutrient composition include age, fitness level, weight, gender, race, menstrual cycle and biological rhythms.

A calibration period may be helpful to understand how specific individuals respond to different amounts of caloric intake, different macronutrients, and different macronutrient rations. In one embodiment, this calibration period includes the step of having an individual eat meals of know caloric amounts and macronutrient composition. These meals may be pre-packaged and provided or these meals may be based off of pre-determined recipes. In one embodiment, the calibration for caloric amount could take place as follows: i) obtain base-line sensor readings for temperature, activity and any other sensors of interest, ii) inform the device that meal 1 is going to be eaten (meal 1 would have a known amount of calories and a known macronutrient ratio), and iii) track sensors for up to six hours post meal. Although the sensors may be tracked for six hours, the numbers of hours may vary and need not be fixed. Temperature readings may be normalized relative to base-line measurements taking into account normalization for activity and ambient temperature.

The changes in body temperature resulting from meal consumption are expected to first increase to a maximum temperature and then gradually decrease to a temperature that is similar to the pre-meal temperature. These temperature changes are shown schematically in FIG. 5. There are three thermal characteristics of these curves that are used in this embodiment for understanding TEF. These characteristics are: i) total thermal response to the meal (TTRₘₑₐₗ), ii) thermogenic maximum (TGMₘₑₐₗ), and iii) time-to-thermogenic maximum (TTMₘₑₐₗ). Total thermal response is the sum of all normalized temperature increases over a defined period of time after meal consumption. Thermogenic maximum is the maximum normalized temperature measured after meal consumption. Time-to-thermogenic maximum is the time, relative to meal consumption, that TGMₘₑₐₗ is measured.

Device calibration could be done by having an individual eat fixed amounts of a single macronutrient and measuring the three thermal characteristics. For example, to understand a specific individual's thermal response to protein the individual would eat a fixed amount of protein at defined time and TTR, TGM, and TTM would be measured. At a different time they would eat a different amount protein and the corresponding TTR, TGM, and TTM would be measured. In this embodiment, this measurement process would be repeated for three or more protein-only meals, where the amount of protein in each meal was different. From this calibration period, an individual's TTR(protein), TGM (protein), and TTM(protein) can be determined (See FIG. 5, Equation 1, Equation 2, and Equation 3). In this embodiment, the equations assume a linear fit to the data, where m (° C.·sec/kcals) is the slope, and b (° C.·sec) is the y-intercept in Equation 1, m (° C./kcals) is the slope, and b (° C.) is the y-intercept in Equation 2, and m (sec/kcals) is the slope, and b (sec) is the y-intercept in Equation 3. In this embodiment, the process is then repeated with the other macronutrients—e.g. carbohydrates and proteins. After this calibration period is complete there will be individual-specific TTR's, TGM's, and TTM's for each macronutrient—e.g. TTR(protein), TGM(protein), TTM(protein), TTR(carbohydrate), TGM(carbohydrate), TTM(carbohydrate), TTR(fat), TGM(fat), and TTM(fat).

TTR(protein)=m·protein(kcals)+b Eq. 1)

TGM(protein)=m·protein(kcals)+b Eq. 2)

TTM(protein)=m·protein(kcals)+b Eq. 3)

In a mixed macronutrient meal, the relative contribution of each macronutrient to the overall TTRₘₑₐₗ, TGMₘₑₐₗ, and TTMₘₑₐₗ may be understood. The relative contribution of each macronutrient to TTRₘₑₐₗ is described by λ. The relative contribution of each macronutrient to TGMₘₑₐₗ is described by γ. The relative contribution of each macronutrient to TTMₘₑₐₗ is a described by δ. The subscript on each these terms denotes the macronutrient (fat, or protein, or carbohydrate). In this embodiment, these λ, γ, and δ's are scalar weighting factors with values between 0 and 1. These values may have to be determined for each individual or may be general values for a defined population.

To determine the overall contribution of each macronutrient to the overall TTRₘₑₐₗ, TGMₘₑₐₗ, and TTMₘₑₐₗ, a matrix of calibration experiments may be performed. Testing three different combinations of macronutrients will provide enough equations to solve for the weighting factors. An example of the process of finding the calibration factors is shown below.

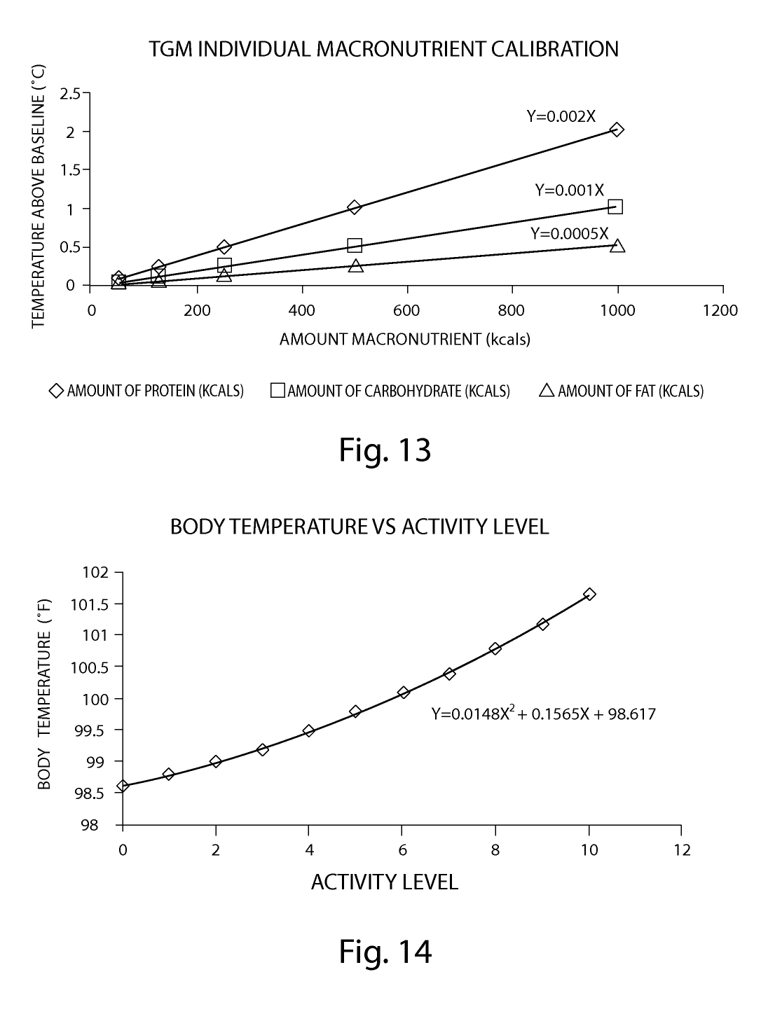

Referring now to FIG. 13, one method of individual macronutrient calibration process for the thermogenic maximum (TGM) characteristic is described. In this embodiment, an individual would consume a plurality of meals of known macronutrient compositions. For example, the individual might eat 50, 125, 250, 500, 1000 of a specific macronutrient and the TGM would be measured for each. Linear regression may be applied to the data set and equation 2 may be applied to all three macronutrients.

TGM(fat)=0.0025·fat(kcals) Eq. 4)

TGM(protein)=0.01·protein(kcals) Eq. 5)

TGM(carb)=0.005·carb(kcals) Eq. 6)

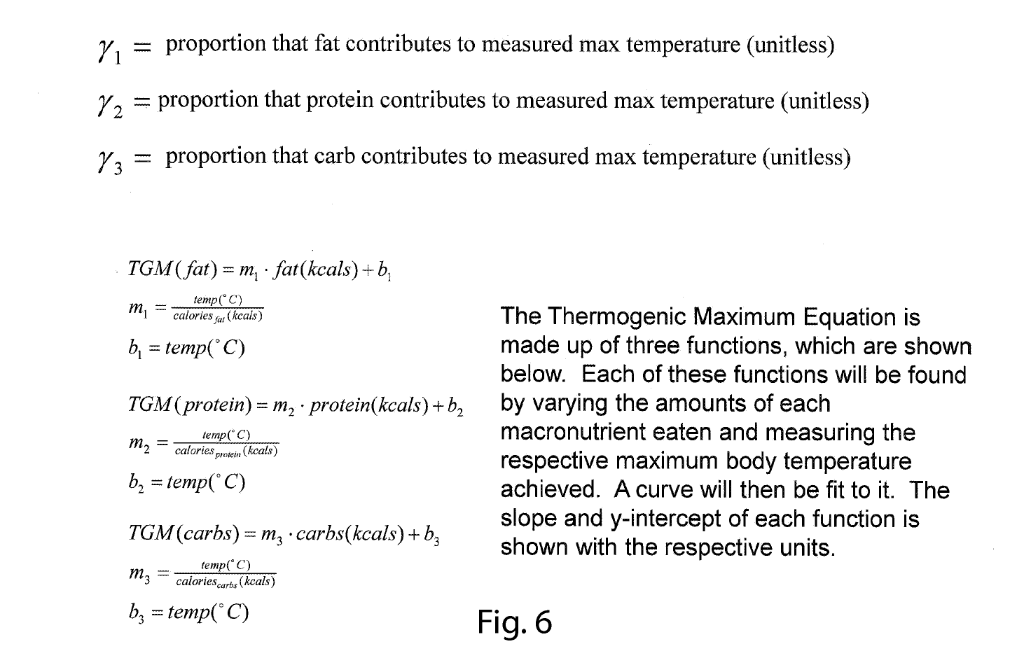

From here, three different meals would be selected to solve for the weighting factors γ₁, γ₂, and γ₃ from FIG. 6. In this embodiment, the selected meals would contain different macronutrient percentages, for example, one meal could be 45% protein, 45% carbohydrates, and 10% fat. The next meal could be 45% protein, 10% carbohydrates, and 45% fat. The final meal could be 10% protein, 45% carbohydrate, and 45% protein. Once the individual ate each of these meals, the TGM for each meal would be measured. Using the equations from FIG. 5 along with equations 4-6, three equations representing the different meal combinations for TGM can be provided. For the example below, a meal of 500 calories will be assumed, which is what the macronutrient percentages will be based on.

1.23(° C.)=(γ_{fat}·0.0025·225(kcals)+γₚᵣₒₜ·0.01·225(kcals)+γ_{carb}·0.005·50(kcals))

0.53(° C.)=(γ_{fat}·0.0025·225(kcals)+γₚᵣₒₜ·0.01·50(kcals)+γ_{carb}·0.005·225(kcals))

1.36(° C.)=(γ_{fat}·0.0025·50(kcals)+γₚᵣₒₜ·0.01·225(kcals)+γ_{carb}·0.005˜225(kcals))

Converting this into matrix notation, Ax=b, gives the following matrix below.

$$[ \begin{matrix}0.563 & 2.25 & 0.25 \\ 0.563 & 0.5 & 1.125 \\ 0.125 & 2.25 & 1.125\end{matrix} ] \cdot [ \begin{matrix}{γ}_{fat} \\ {γ}_{prot} \\ {γ}_{carb}\end{matrix} ] = [ \begin{matrix}1.23 \\ 0.53 \\ 1.36\end{matrix} ]$$

Solving for the vector x gives the proportionality constants for the TGM equation.

$$x = [ \begin{matrix}0.1 \\ 0.5 \\ 0.2\end{matrix} ]$$

This would then be done for each characteristic (i.e. TTR and TTM) in the same way to determine each set of proportionality constants from FIGS. 6-8.

After the macronutrient thermal characteristics are characterized and their respective weighting factors are known, the measured TTRₘₑₐₗ, TGMₘₑₐₗ, and TTMₘₑₐₗ of a meal of unknown caloric and macronutrient composition can be used in Equation 4, Equation 5, and Equation 6 below to determine the caloric content of each macronutrient.

TTRₘₑₐₗ=(λ_{fat}·TTR(fat)+λₚᵣₒₜ·TTR(protein)+λ_{carb}·TTR(carb)) Eq. 7)

TGMₘₑₐₗ=(γ_{fat}·TGM(fat)+γₚᵣₒₜ·TGM(protein)+γ_{carb}·TGM(carb)) Eq. 8)

TTMₘₑₐₗ=(δ_{fat}·TTM(fat)+δₚᵣₒₜ·TTM(protein)+δ_{carb}·TTM(carb)) Eq. 9)

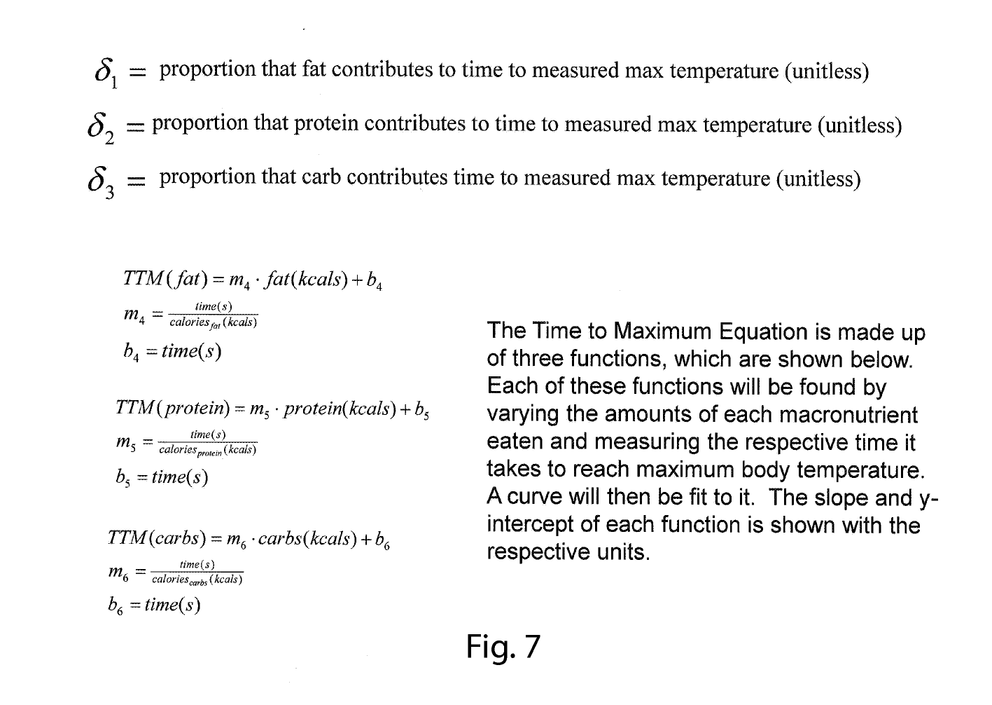

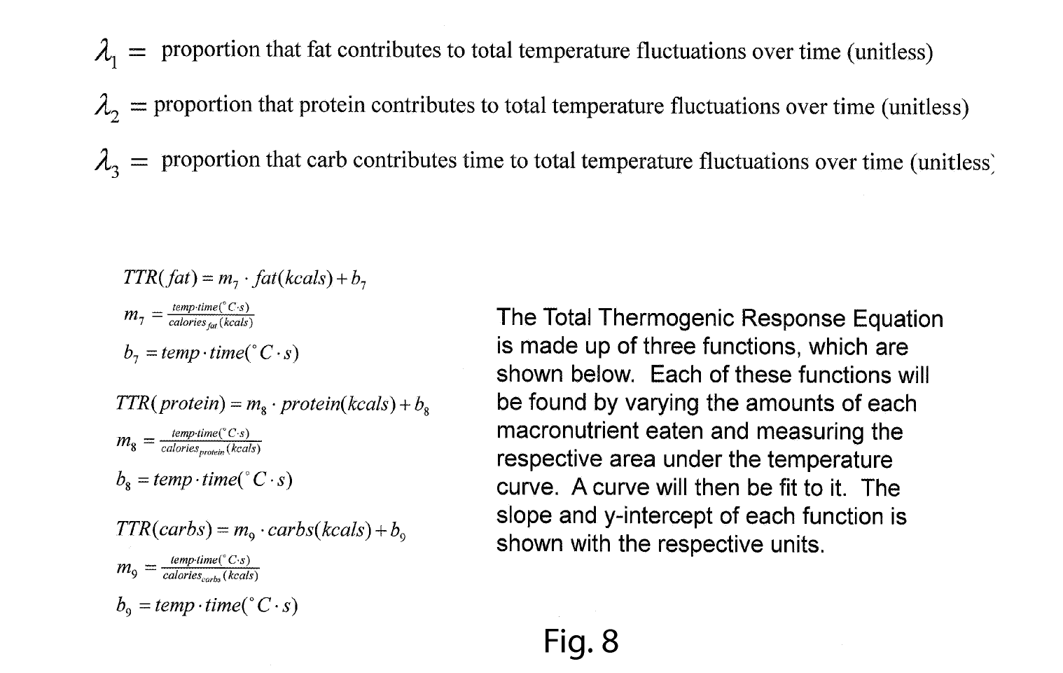

Combining Equations 7, Equation 8, and Equation 9 with the equations shown in FIG. 6, FIG. 7, and FIG. 8 results in Equation 10, Equation 11, and Equation 12. Combined, these three equations have three unknowns, protein (kcals), fat (kcals), and carbohydrate (kcals). The slopes, m, y-intercept values, b, and weighting factors are all known from the calibration periods described above. Using known techniques, we can now solve for these three unknowns from these three equations.

TTRₘₑₐₗ=(λ_{fat}·(m₇·fat(kcals)+b₇)+λₚᵣₒₜ·(m₈·protein(kcals)+b₈)+λ_{carb}·(m₉·carb(kcals)+b₉)) Eq. 10)

TGMₘₑₐₗ=(γ_{fat}·(m₁·fat(kcals)+b₁)+γₚᵣₒₜ·(m₂·protein(kcals)+b₂)+γ_{carb}·(m₃·carb(kcals)+b₃)) Eq. 11)

TTMₘₑₐₗ=(δ_{fat}·(m₄·fat(kcals)+b₄)+δₚᵣₒₜ·(m₅·protein(kcals)+b₅)+b₅)+δ_{carb}·(m₆·carb(kcals)+b₆)) Eq. 12)

As can be seen, the present invention provides some examples of systems and methods for approximating caloric energy intake and/or macronutrient composition. As described, determining macronutrient composition may be an integral part of determining caloric energy intake. The above description provides examples of systems and methods for normalizing raw temperature readings to compensate for factors other than TEF that might impact raw temperature readings. Similarly, the above description provides examples of systems and methods that include calibration to compensate for variations between individual users. The examples set forth are exemplary and should not be interpreted to limit the scope of the present invention to specific normalization and calibration systems and methods.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. An apparatus for estimating caloric energy intake of a meal comprising:
a body temperature sensor configured to provide body temperature readings;
an ambient temperature sensor configured to provide ambient temperature readings;
a physical activity sensor configured to provide physical activity readings; and
a processor configured to provide normalized temperature readings by normalizing said body temperature readings as a function of said ambient temperature readings and said physical activity readings, said processor configured to compute caloric energy intake as a function of said normalized body temperature readings.

2. The apparatus of claim 1 wherein said processor is configured to take body temperature readings for a period of time associated with a meal.

3. The apparatus of claim 2 wherein said processor is configured to compute caloric energy intake as a function of a total thermal response of the meal, a thermogenic maximum of the meal and a time-to-thermic maximum of the meal.

4. The apparatus of claim 1 wherein said body temperature sensor, said ambient temperature sensor, said physical activity sensor and said processor are contained in a personal device capable of being worn by an individual.

5. The apparatus of claim 1 wherein said body temperature sensor includes a plurality of body temperature sensors disposed at different locations.

6. The apparatus of claim 5 wherein at least one of said body temperature sensors is remote from said processor, said remote body temperature sensor having a wireless communication system for wirelessly communication said body temperature readings to said processor.

7. The apparatus of claim 1 wherein said physical activity sensor includes a three-axis accelerometer.

8. The apparatus of claim 1 wherein said processor includes predetermined calibration data representing the user's response to macronutrients, said processor configured to compute caloric energy intake as a function of said normalized body temperature readings and said calibration data.

9. The apparatus of claim 1 wherein said processor is disposed in a device; and
said body temperature sensor is disposed in a remote sensor separate from said device, said remote sensor being configured to be fitted into the user's ear.

10. The apparatus of claim 9 wherein said remote sensor includes a wireless communication circuit for communicating said body temperature readings to said device.

11. The apparatus of claim 10 wherein said remote sensor includes a data storage for storing said body temperature readings.

12. A system for determining caloric energy intake of food consumed by an individual comprising:
a body temperature sensor arranged to take raw body temperature readings reflective of core body temperature of the individual;
a first normalization factor sensor, said first normalization factor sensor configured to take first normalization factor readings reflective of a first factor other than a thermic effect of food that can impact core body temperature of the individual;
a processor configured to provide normalized temperature readings by normalizing said raw body temperature readings as a function of said first normalization factor readings, said processor configured to compute caloric energy intake as a function of said normalized body temperature readings.

13. The system of claim 12 wherein said first normalization factor sensor includes at least one of an ambient temperature sensor and a physical activity sensor.

14. The system of claim 12 further including a second normalization factor sensor, said second normalization factor sensor configured to take second normalization factor readings reflective of a second factor different from said first factor and other than a thermic effect of food that can impact core body temperature of the individual.

15. The system of claim 14 wherein said first normalization factor sensor is an ambient temperature sensor and said second normalization factor sensor is a physical activity sensor.

16. The system of claim 12 wherein said body temperature sensor is configured to take body temperature readings for a period of time associated with a meal.

17. The system of claim 16 wherein said processor is configured to compute caloric energy intake as a function of a total thermal response of the meal, a thermogenic maximum of the meal and a time-to-thermic maximum of the meal.

18. The system of claim 12 wherein said processor includes predetermined calibration data representing the user's response to macronutrients, said processor configured to compute caloric energy intake as a function of said normalized body temperature readings and said calibration data.

19. The system of claim 12 wherein said processor is disposed in a personal device capable of being worn by a user; and
said body temperature sensor is disposed in a remote sensor separate from said personal device, said remote sensor being configured to be fitted into the user's ear.

20. The system of claim 19 wherein said remote sensor includes a wireless communication circuit for communicating said body temperature readings to said personal device.

21. The system of claim 20 wherein said remote sensor includes a data storage for storing said body temperature readings.

22. A method for determining caloric energy intake of a meal, comprising the steps of:
measuring body temperature readings of a user;
normalizing the body temperature readings based on at least one normalization factor, the normalization factor being a factor impacting the body temperature readings other than thermic effect of food; and
computing caloric energy intake of the meal from the normalized body temperature readings.

23. The method of claim 22 wherein said step of normalizing includes the steps of sensing ambient temperature and adjusting the measured body temperature readings as a function of the sensed ambient temperature.

24. The method of claim 22 wherein said step of normalizing includes the steps of sensing physical activity of the user and adjusting the measured body temperature readings as a function of the sensed physical activity.

25. The method of claim 22 wherein said step of normalizing includes the steps of sensing time of day and adjusting the measured body temperature readings as a function of the sensed time of day.

26. The method of claim 22 wherein said step of normalizing includes the steps of sensing UV exposure and adjusting the measured body temperature readings as a function of the sensed UV exposure.

27. The method of claim 22 wherein said step of normalizing includes the steps of sensing user sweat level and adjusting the measured body temperature readings as a function of the sensed user sweat level.

28. The method of claim 22 wherein said step of normalizing includes the steps of:
sensing ambient temperature;
adjusting the measured body temperature readings as a function of the sensed ambient temperature;
sensing physical activity of the user; and
adjusting the measured body temperature readings as a function of the sensed physical activity.

29. The method of claim 28 wherein said step of sensing ambient temperature includes collecting temperature readings from a plurality of temperature sensors located at different positions on the user's body.

30. The method of claim 29 wherein said step of sensing physical activity includes the step of collecting readings from an accelerometer.

31. The method of claim 29 wherein said step of sensing physical activity includes the step of collecting readings from a three-axis accelerometer.

32. The method of claim 22 wherein said step of computing caloric energy intake includes determining a ratio of at least two different macronutrients.

33. The method of claim 22 wherein said step of computing caloric energy intake includes determining a ratio of fat, protein and carbohydrates in a meal.

34. The method of claim 22 wherein said step of computing caloric energy intake includes computing caloric intake as a function of said ratio of fat, protein and carbohydrates in a meal.

35. A method of computing caloric energy intake of a user for a meal, comprising the steps of:
measuring raw body temperature readings of the user;
measuring physical activity of the user;
measuring ambient temperature of an environment around the user;
normalizing the raw body temperature readings of the user based on the measured physical activity of the user and the measured ambient temperature; and
computing caloric energy intake as a function of the normalized body temperature readings.

36. The method of claim 35 wherein said step of computing caloric energy intake includes the steps of:
developing a temperature profile;
determining a total thermal response of the meal from the temperature profile;
determining a thermogenic maximum of the meal from the temperature profile;
determining a time-to-thermic maximum of the meal from the temperature profile; and
determining caloric energy intake as a function of the total thermal response, the thermogenic maximum and the time-to-thermic maximum.

37. The method of claim 35 wherein said step of computing caloric energy intake includes the steps of:
developing a temperature profile;
determining a total thermal response from the temperature profile for each of fats, carbohydrates and proteins;
determining a thermogenic maximum from the temperature profile for each of fats, carbohydrates and proteins;
determining a time-to-thermic maximum from the temperature profile for each of fats, carbohydrates and proteins; and
determining caloric energy intake as a function of the total thermal response, the thermogenic maximum and the time-to-thermic maximum for each of fats, carbohydrates and proteins.

38. The method of claim 37 further including the steps of:
determining a total thermal response of the meal as a function of the total thermal response for each of fats, carbohydrates and proteins;
determining a thermogenic maximum of the meal as a function of the thermogenic maximum of fats, carbohydrates and proteins;
determining a time-to-thermic maximum of the meal as a function of the time-to-thermic maximum of fats, carbohydrates and proteins; and
determining caloric energy intake as a function of the total thermal response of the meal, the thermogenic maximum of the meal and the time-to-thermic maximum of the meal.

39. The method of claim 38 further including the steps of determining a relative contribution of fats, carbohydrates and proteins to the total thermal response of the meal, the thermogenic maximum of the meal and the time-to-thermic maximum of the meal; and
wherein said step of determining caloric energy intake as a function of the total thermal response of the meal, the thermogenic maximum of the meal and the time-to-thermic maximum of the meal includes the step of accounting of the relative contribution of fat, carbohydrates and proteins.

40. The method of claim 38 further including the step of determining calibration data representative of a relative contribution of fats, carbohydrates and proteins to the total thermal response of the meal, the thermogenic maximum of the meal and the time-to-thermic maximum of the meal; and
wherein said step of determining caloric energy intake includes determining caloric energy intake as a function of the total thermal response of the meal, the thermogenic maximum of the meal and the time-to-thermic maximum of the meal calibrated by the calibration data.
